(19) United States
(12) Patent Application Publication
(10) Pub. No.: US 2006/0026876 A1
(43) Pub. Date: Feb. 9, 2006

(54) Adjustable support for end cap display

(75) Inventors: Walter Murphy, Douglasville, GA (US); Dena Johnston, Social Circle, GA (US); Chris Dunn, Roswell, GA (US); Tom Jordan, Marietta, GA (US)

Correspondence Address: H. JAY SPIEGEL, P.O. BOX 11, Mount Vernon, VA, 22121, US

(73) Assignee: MILLER ZELL, INC.

(21) Appl. No.: 10/910,639

(22) Filed: Aug. 4, 2004

(51) Int. Cl. G09F 7/00

(52) U.S. Cl. 40/601

(57) ABSTRACT

A display includes a support on which a sign is hung depending downwardly. The support has a vertically elongated rod on which it is supported that is guided vertically through two guides that are vertically spaced from one another to permit the rod to slide up and down on the guides. Adjacent the lower guide, a locking mechanism is provided including a slot. At the lower end of the rod, a handle is provided that also includes structure allowing it to be interlocked with the slot of the locking mechanism to hold the vertically elongated rod and display in its uppermost position. The handle may be unhooked from the locking mechanism with the vertically elongated rod being pivoted about its axis of elongation, whereupon the rod with the display attached are lowered together. In the lowermost position of the display, the display may be changed or even cleaned.

### BACKGROUND OF THE INVENTION

The present invention relates to an adjustable support for end cap display. In retail establishments, shelving typically includes an end cap that encloses the shelves that hold merchandise. The location above the end cap is an ideal location to display a sign that directs customers to the locations of merchandise, provides pricing information, or includes advertising of various products and/or services.

The typical retail store shelf, including an end cap, is six feet high or higher. Thus, when it is desired to include a sign mounted above an end cap, the sign is at a higher elevation than it is reasonably possible to reach by a store employee. Thus, when it is desired to change the sign above the end cap, typically, the employee must use a ladder to climb up to an elevation permitting access to the sign. Use of ladders in the aisle of a busy retail establishment is a dangerous practice. The ladder may be struck by a customer's cart or may slip if there is any moisture on the floor on which the ladder sits. Employees often are not cognizant of the dangers of standing on too high a step on a ladder and ladders can sometimes tip over with disastrous consequences.

As such, if it were possible to devise a sign for mounting above a shelf such as an end cap in which a store employee need not use a ladder or other elevating mechanism to access the sign to change it, enhanced safety and effectiveness as well as efficiency would result. It is with these thoughts in mind that the present invention was developed.

### SUMMARY OF THE INVENTION

The present invention relates to an adjustable support for end cap display. The present invention includes the following interrelated objects, aspects and features:

(1) In a first aspect, the present invention contemplates a display that is intended to be mounted over an end cap. Of course, the present invention could also easily be mounted above any shelving system provided there is room for the mechanism to swing to allow it to be lowered.

(2) The inventive device includes a bracket mounted on the end cap and, in its preferred embodiment, on which a lifting and lowering device including a horizontally oriented rod is supported, from which a sign is hung depending downwardly therefrom. The sign may be supported on the rod using any suitable means such as hooks, screws, etc.

(3) The bracket also supports a vertically oriented rod attached to the horizontally oriented rod. The vertically oriented rod is guided vertically and rotatably through guide means comprising two guides on the bracket that are vertically spaced from one another to permit the rod to slide up and down on the guides.

(4) Adjacent the lower guide, a locking means or mechanism is provided including a slot. At the lower end of the vertically oriented rod, a handle is provided that also includes a portion of the structure of the locking mechanism allowing the vertically oriented rod to be interlocked with the slot of the locking mechanism to hold the display in its uppermost position.

(5) When it is desired to lower the display to allow the display to be changed or cleaned, the handle is unhooked from the slot with the vertically oriented rod being pivoted about its axis of elongation, whereupon the vertically oriented and horizontally oriented rods with the display attached thereto are lowered together until the horizontal rod engages the upper guide, thereby stopping further downward movement thereof.

(6) In the lowermost position of the display, the display may be changed or even cleaned. Then, the handle may be gripped and the rods with the display mounted thereon may be raised, pivoted into place, and the handle may again be interlocked with the slot of the locking mechanism to hold the display in the uppermost position thereof.

As such, it is a first object of the present invention to provide an adjustable support for end cap display.

It is a further object of the present invention to provide such a device in which a horizontally oriented rod has a display mounted thereon, and the horizontally oriented rod is mounted on a vertical rod.

It is a yet further object of the present invention to provide such a device in which a gripping handle mounted on the vertically oriented rod may interlock with a slot to lock the display in its uppermost position.

It is a still further object of the present invention to provide such a device in which the handle may be disengaged from the locking mechanism slot to allow the display to be lowered to an elevation allowing an employee of a retail establishment to change the display or clean it without having to use a ladder, step stool, or other elevating device.

These and other objects, aspects and features of the present invention will be better understood from the following detailed description of the preferred embodiment when read in conjunction with the appended drawing figures.

### BRIEF DESCRIPTION OF THE DRAWINGS

FIG. 1 shows a perspective view of an end cap having the present invention mounted thereon.

FIG. 2 shows an enlarged view from a different perspective from that of FIG. 1, but with the parts in the same orientation as shown in FIG. 1.

FIG. 3 shows a further enlarged view of a portion of FIG. 2.

FIG. 4 shows a perspective view of an end cap with the inventive device mounted thereon, but turned to a second orientation and lowered in accordance with the teachings of the present invention.

FIG. 5 shows the orientation of parts shown in FIG. 4, but from a different perspective.

FIG. 6 shows a view from the same perspective as that of FIG. 5, but showing the display in the position shown in FIG. 1 in phantom.

### SPECIFIC DESCRIPTION OF THE PREFERRED EMBODIMENT

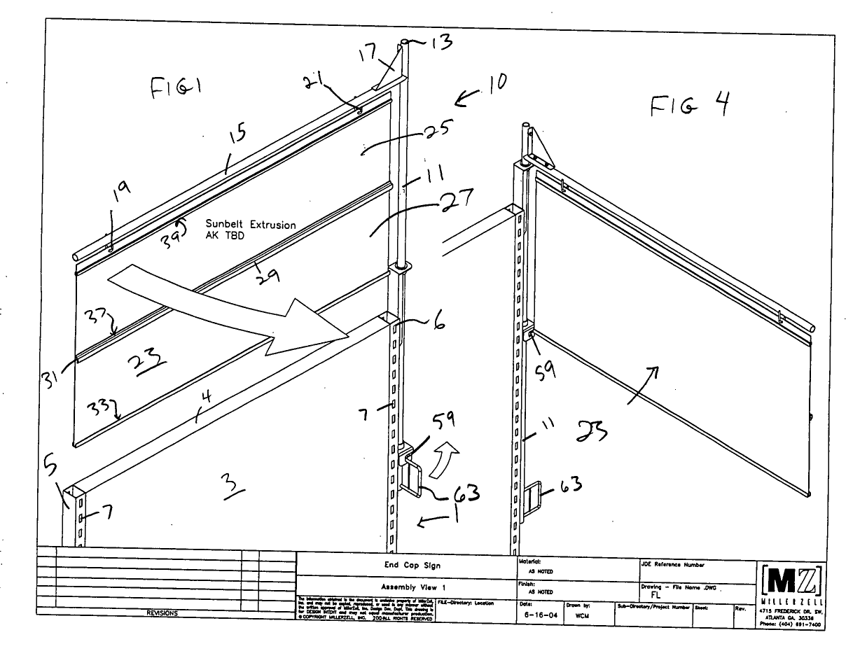

With reference first to FIG. 1, an end cap is generally designated by the reference numeral 1, and is seen to include a vertically oriented wall 3 having a top surface 4 and side supports 5 and 6, each having a plurality of holes 7 therethrough which are designed to permit attachment of hooks or other display items.

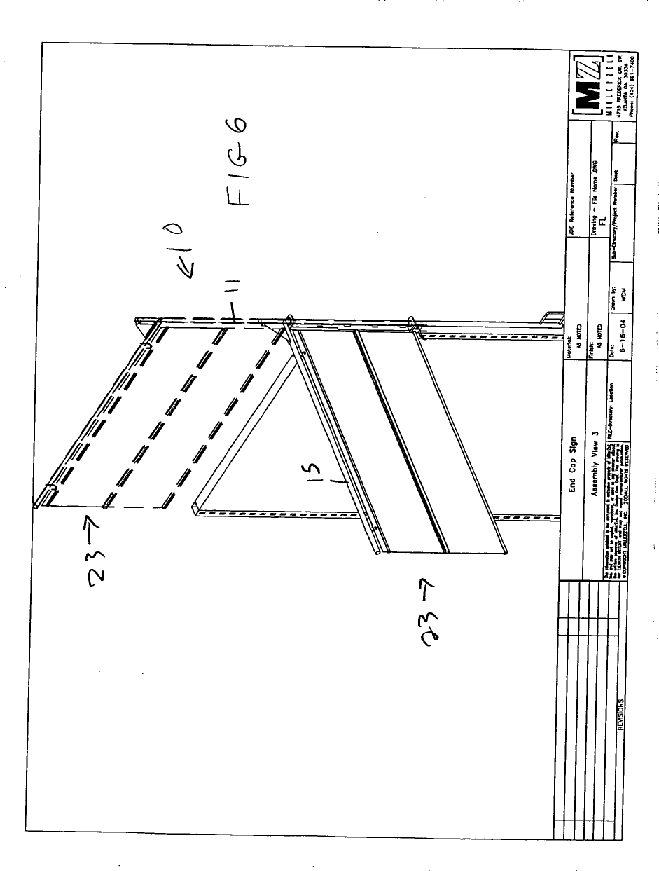

With reference to FIG. 1, the present invention is generally designated by the reference numeral 10, and is seen to include a vertical rod 11 having an upper extent 13 to which is attached a perpendicular horizontal rod 15 by virtue of a bracket 17. The bracket 17 is connected between the rods 11 and 15 through any suitable means such as, for example, welding. The horizontal rod includes, in one example, hooks 19 and 21 attached thereto by any suitable means such as, for example, welding. Depending downwardly from the rod 15 and held in place by the hooks 19 and 21 is a display 23 consisting of a sign. The display 23 includes, in one embodiment, regions 25 and 27. For example, the region 27 is defined by an elongated member 29 having a downwardly depending slot 31 that faces an upwardly facing slot 33 defining the bottom edge of the display 23. The spacing between the slots 31 and 33 is provided to allow display indicia such as, for example, letters and numbers on rectangular cards 24 (FIG. 5) to be slid between the slots 31 and 33 and held thereby to provide information to customers such as, for example, pricing or product description. The upper region 25 of the display is defined by a lower slot 37 and an upper slot 39 which operate in the same way as the slots 31 and 33.

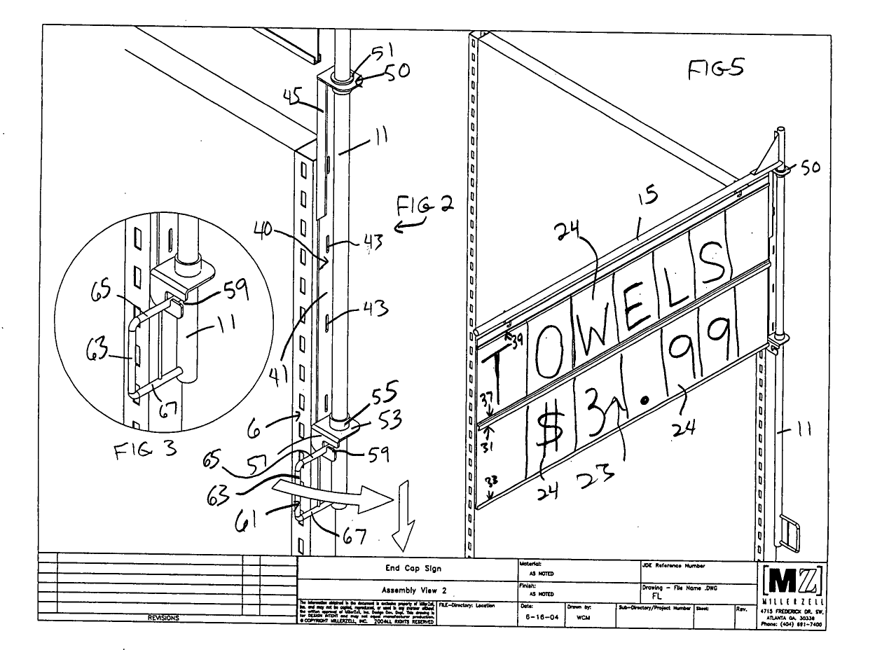

With particular reference to FIG. 2, a vertical support bracket 40 is seen to include a flat elongated vertical strip 41 mounted on an end surface of the strip 6. The support bracket 40 is mounted to the strip 6 using any suitable means. For example, the support bracket 40 may be provided with slots 43 that allow receipt of fastening means such as, for example, threaded fasteners, to affix the support bracket 40 on the strip 6. The support bracket 40 includes a strengthener consisting of an elongated flat piece 45 that reinforces the support bracket 40 where it extends above the upper extent of the strip 6. The upper extent of the support bracket 40 is defined by guide means including an upper guide mechanism 50 that is attached to the strip 6 and the plate 45 by any suitable means such as, for example, welding. The upper guide mechanism 50 includes a bearing 51 defining an opening sized to allow the rod 11 to slide therethrough and rotate with respect thereto. Similarly, the guide means also includes a lower guide mechanism 53 that is mounted near the lower extent of the strip 41 as seen in FIG. 2, in particular. The lower guide mechanism 53 includes a further bearing 55 that allows the rod 11 to slide therethrough and rotate with respect thereto.

The lower guide mechanism 53 also includes a downwardly depending wall 57 in which an L-shaped slot 59 is formed. At the lower end of the rod 11, a C-shaped appendage 61 is mounted on the rod 11. The appendage 61 serves a dual purpose. It includes a vertically oriented rod 63 that serves as a gripping member or handle designed to be gripped by the hand of a user. At the upper extent of the rod 63, a horizontally extending rod 65 extends therefrom and is mounted onto the rod 11. A lower horizontal rod 67 is provided to stabilize the rods 63 and 65 with the rod 67 mounted between the lower extent of the rod 63 and the rod 11.

The upper rod 65 is sized and configured to be able to be received within the slot 59 as seen in FIGS. 2 and 3, in particular.

Thus, with reference to FIGS. 1-3, with the rod 65 received within the slot 59, the display 23 is in its desired position in which it is fixedly located above the end cap 1 so that it may display wording, pricing or other display information (FIG. 5) in the position shown, for example, in FIG. 1.

When it is desired to lower the display 23 so that it may be changed or cleaned, with reference to FIGS. 2 and 3, the user may grip the vertical rod 63 as a handle and lift up until the horizontal rod 65 is lifted from the downwardly depending portion of the slot 59 (FIG. 3), whereupon the handle 63 may be pivoted, carrying the rod 11 and display 23 with it until the rod 11 and the display 23 arrive at the position shown in FIG. 4, which occurs after the rod 11 has been pivoted about its axis of elongation about 90° and then lowered. The lowering of the rod 11 may clearly be seen from comparison of FIGS. 1 and 4.

With reference to FIG. 5, the rod 11 may be further lowered until the horizontal rod 15 engages the upper guide mechanism 50 to stop any further lowering of the display 23. Comparison of the raised and lowered positions of the display 23 is provided in FIG. 6. In the position shown in FIG. 5, the display 23 may easily be accessed by the employee of the retail establishment without use of a ladder or step stool so that the display may be changed or cleaned. Once this has been accomplished, the display may be restored to the position shown in FIG. 1, in particular, by grabbing the rod 63 as a handle, lifting the rod 11 to its uppermost extent, and then rotating the rod 11 about 90° about its axis of elongation until the horizontal rod 65 enters the slot 59 in the lower guide mechanism 53, whereupon the position and orientation best seen in FIGS. 2 and 3 is restored to lock the display 23 in the position shown in FIG. 1 in which it is in position for display purposes.

In this way, a display is provided that is equally effective as any displays currently on the market, but has the added advantage of a mechanism permitting it to be changed and/or cleaned without the need to use a ladder, step stool, or other elevating device.

In the preferred embodiment of the present invention, the rods 11 and 15 are made of any suitable strong metallic material as are the upper and lower guide mechanisms 50 and 53. The handle 61 may also be made of any suitable metal material. The display 23 may be made of metal or plastic and the numbers, letters or symbols that are inserted within the slots formed on the display 23 (FIG. 1) may be made of any suitable material such as metal, plastic, paper or the like.

As such, an invention has been disclosed in terms of a preferred embodiment thereof which fulfills each and every one of the objects of the invention as set forth hereinabove, and provides a new and useful adjustable support for end cap display of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. An adjustable support for a display, comprising:
a) a display;
b) said display mounted on a lifting and lowering device;
c) said lifting and lowering device including:
i) a vertical support attached to said display;
ii) guide means mounted on a structure for guiding vertical movements of said vertical support; and
iii) locking means for locking said display in an uppermost position thereof;
d) said locking means being selectively releaseable to permit lowering said display to an elevation permitting access to said display.

2. The support of claim 1, wherein said display is flat.

3. The support of claim 2, wherein said display includes a track adapted to receive rectangular cards with numbers and/or letters printed thereon.

4. The support of claim 1, wherein said vertical support comprises an elongated vertical rod.

5. The support of claim 4, wherein a horizontal rod is attached to said vertical rod, said display hanging from said horizontal rod.

6. The support of claim 1, wherein said guide means comprises vertically spaced guide members, each guide member having a bearing with an opening therethrough, said openings being aligned along a vertical axis.

7. The support of claim 6, wherein said vertical support comprises an elongated rod received through said openings.

8. The support of claim 7, wherein said locking means comprises a plate on a lowermost portion of a lower one of said guide members and a slot in said plate, said elongated rod having a horizontal rod attached thereto, said horizontal rod being sized to enter said slot to lock a vertical position of said elongated rod.

9. The support of claim 7, wherein said elongated rod is rotatable and reciprocable within said openings.

10. The support of claim 9, wherein said locking means comprises a plate on a lowermost portion of a lower one of said guide members and a slot in said plate, said elongated rod having a horizontal rod attached thereto, said horizontal rod being sized to enter said slot to lock a vertical position of said elongated rod.

11. The support of claim 10, wherein said elongated rod is rotated to cause said horizontal rod to enter and leave said slot.

12. The support of claim 11, further including a further horizontal rod at an upper end of said elongated rod, said further horizontal rod supporting said display.

13. The support of claim 8, wherein said slot extends from an access opening thereof horizontally and then vertically in a vertical slot portion.

14. The support of claim 13, wherein said horizontal rod enters said vertical slot portion to lock said horizontal rod in said slot.

15. The support of claim 8, wherein a vertical rod is attached to said horizontal rod and comprises a handle.

16. The support of claim 14, wherein a vertical rod is attached to said horizontal rod and comprises a handle.

17. An adjustable support for a display, comprising:
a) a rectangular display;
b) said display mounted on a lifting and lowering device;
c) said lifting and lowering device including:
i) a support attached to said display comprising a vertically elongated rod;
ii) guide means mounted on an end cap for guiding vertical and rotative movements of said vertically elongated rod, said guide means comprising vertically spaced guide members, each guide member having a bearing with an opening therethrough, said openings being aligned along a vertical axis, said openings receiving said vertically elongated rod; and
iii) locking means for locking said display in an uppermost position thereof;
d) said locking means being selectively releaseable to permit lowering said display to an elevation permitting said display to be accessed.

18. The support of claim 17, wherein said display is flat and includes a track adapted to receive rectangular cards with numbers and/or letters printed thereon.

19. The support of claim 17, wherein said locking means comprises a plate on a lowermost portion of a lower one of said guide members and a slot in said plate, said vertically elongated rod having a horizontal rod attached thereto, said horizontal rod being sized to enter said slot to lock a vertical position of said elongated rod.

20. The support of claim 19, wherein said vertically elongated rod is rotated to cause said horizontal rod to enter and leave said slot, and further including a vertical rod attached to said horizontal rod and comprising a handle.
